(19) United States
(12) Patent Application Publication
(10) Pub. No.: US 2018/0252193 A1
(43) Pub. Date: Sep. 6, 2018

(54) FUEL PUMP HOUSING

(71) Applicant: DELPHI TECHNOLOGIES IP LIMITED, St. Michael (BB)

(72) Inventors: Matthew Fairbairn, Longfield Kent (GB); Paul Francis Garland, Gillingham Kent (GB); Toby Pedley, London (GB)

(21) Appl. No.: 15/758,949

(22) PCT Filed: Sep. 6, 2016
(86) PCT No.: PCT/EP2016/070997

§ 371 Date: Mar. 9, 2018

(30) Foreign Application Priority Data
Sep. 11, 2015 (GB) 1516152.4

(51) Int. Cl. F02M 59/44; F02M 55/02; F02M 59/02

(52) U.S. Cl. CPC F02M 59/44; F02M 59/025; F02M 55/025

(57) ABSTRACT

A fuel pump housing includes a pumping chamber that is substantially spherical and a drilling intersecting the pumping chamber at an opening. The drilling transitions into the pumping chamber at a transition region of progressively increasing diameter. The transition region and the spherical pumping chamber are configured such that a peak stress in the fuel pump housing is at a location that is spaced away from the opening.

### CROSS REFERENCE TO RELATED APPLICATIONS

This application is a national stage application under 35 USC 371 of PCT Application No. PCT/EP2016/070997 having an international filing date of Sep. 6, 2016, which is designated in the United States and which claimed the benefit of GB Patent Application No. 1516152.4 filed on Sep. 11, 2015, the entire disclosures of each are hereby incorporated by reference in their entirety.

### TECHNICAL FIELD

The invention relates to a fuel pump housing. In particular, the invention relates to a fuel pump housing for use in a common rail fuel injection system of a diesel engine for a vehicle.

### BACKGROUND TO THE INVENTION

Fuel pump housings typically comprise a pumping chamber that is intersected by passages or drillings. Fuel flows into and out of the pumping chamber via these drillings

FIG. 1 shows part of a known pump assembly for use in a common rail fuel injection system of a diesel engine. The pump assembly includes a fuel pump housing 10 provided with a blind bore 12 within which a pumping plunger (not shown) reciprocates, in use, under the influence of a drive arrangement (also not shown). The plunger and its bore 12 extend co-axially through the pump housing 10. A top region of the blind bore 12 defines a cylindrical pumping chamber 14. An inlet passage 16 and an outlet passage 18 each intersect with the pumping chamber 14. The outlet passage 18 intersects the pumping chamber 14 at an opening 13.

Fuel at relatively low pressure is delivered to the cylindrical pumping chamber 14 through the inlet passage 16 under the control of an inlet non-return valve (not shown). The fuel is pressurised within the pumping chamber 14 as the plunger reciprocates within the bore 12 and, once pressure reaches a predetermined level, fuel is delivered to the outlet passage 18, via an outlet valve (not shown), which extends transversely to the bore 12. The outlet passage 18 then delivers pressurised fuel to a downstream common rail of the fuel injection system.

High-pressure fluid in the plunger bore 12, the outlet passage 18 and the cylindrical pumping chamber 14 of the fuel pump of FIG. 1 acts upon the walls of the pump housing 10 to create high stress concentrations, particularly at the region of intersection between the plunger bore 12, the outlet passage 18 and the cylindrical pumping chamber 14. As the plunger reciprocates within its bore 12 and fuel is pressurised to a high level within the pumping chamber 14, a pulsating tensile stress occurs within the pump housing 10 that can cause cracks to grow, which can lead to fatigue failure at or close to the intersection.

Stress concentrations can be induced in particular in and around the outlet passage 18. The outlet passage 18 of the pump assembly intersects with the pumping chamber 14 via an intersection region 20 and there is an abrupt transition between the intersection region 20 and the pumping chamber 14, where upper 22a and lower 22b surfaces of the intersection region 20 meets the cylindrical surface of the pumping chamber 14. The sharpness of this transition results in a concentration of hoop stress at the intersection 20 and around the opening 13.

Furthermore, as illustrated in FIG. 2 owing to the cylindrical shapes of the outlet passage 18 and the pumping chamber 14 the opening 13 between the two cylindrically-shaped passages is elliptical. In particular, the lateral 24 surfaces of the outlet passage 18, extend further to meet the pumping chamber 14 than the upper and lower surfaces 22a, 22b. This results in uneven stresses around the opening 13 which leads to regions of stress concentration.

Attempts have been made to mitigate stress concentrations in fuel pump housings. For example, it has previously been shown that the stress concentrations at the intersection between fluid passages can be reduced by shaping the intersection at the end of one passage to remove sharp features and thin regions of material at the, for example by radiusing the intersection.

The Applicant's granted European Patent No. EP 06256052 describes a more sophisticated shaping of the intersection between the cylindrical outlet passage and the cylindrical pumping chamber by providing an intersection region in which the outlet passage flares towards the pumping chamber from a circular cross section to a generally rectangular cross-section. A radius is provided on the flare to smooth the transition between the flare and the plunger bore. EP 2320084, describes a yet more sophisticated shaping of the intersection between the outlet passage and the pumping chamber, in which the firstly the height of the pumping chamber is reduced to substantially the diameter of the outlet passage, and secondly the outlet passage flares only in a plane perpendicular to the axis of the plunger bore, such that the upper and lower surfaces of the intersection are substantially flat.

Both of these approaches have been successfully utilised in high pressure pump applications as a means of reducing the stress concentrations at the intersection between the outlet passage and the plunger bore. However, increasingly high pressures are demanded of common rail pumps, and it would be desirable to reduce stress concentrations even further to accommodate even higher fuel pressures.

It is an object of the present invention to provide a high-pressure fuel pump housing, and more generally a housing for high-pressure fluid applications in which the stress concentrations between intersecting passages are reduced further compared to known solutions.

### SUMMARY OF THE INVENTION

According to a first aspect of the present invention, there is provided a fuel pump housing for use in a fuel pump of a common rail fuel injection system in a vehicle engine, the fuel pump housing comprising a pumping chamber for receiving pressurised fuel and a drilling intersecting the pumping chamber at an opening, wherein the pumping chamber is substantially spherical, wherein the drilling transitions into the pumping chamber at a transition region of progressively increasing diameter, and wherein the transition region and the spherical pumping chamber are configured such that, when the fuel pump housing is in use, a peak stress in the fuel pump housing is at a location that is spaced away from the opening.

A synergistic relationship between the spherical shape of the pumping chamber and the progressively increasing diameter of the transition region results in a reduction of stress in the drilling, and in particular results in the peak stress being located away from the opening between the drilling and the pumping chamber. The spherical shape of the pumping chamber results in a relatively low hoop stress in the pumping chamber, and also acts to evenly distribute stresses applied to the drilling, leading to a substantially even circumferential distribution of stress within the drilling. The progressively increasing diameter of the transition region reduces the stress at the opening between the drilling and the pumping chamber. The combination of these effects leads unexpectedly to the peak stress in the pump housing surrounding the drilling being located away from the opening. Instead the peak stress is located at a position along the drilling where it can be more readily accommodated.

The peak stress in the fuel pump housing is therefore lower and at a different location compared to the peak stress in known fuel pump housings. When the peak stress is spaced away from the opening, the peak stress is less affected by the geometry of the pumping chamber, and is also less affected by the cyclical stresses induced in the pumping chamber during use. As a result, the peak stress undergoes less intense fluctuations due to cycling stresses in the pumping chamber and is less vulnerable to fatigue. The fuel pump housing is therefore less prone to failure, and can accommodate higher fuel pressures.

The invention is particularly advantageous when used in conjunction with a fuel pump for high-pressure fuel. High-pressure fuel is generally understood to mean fuel pressurised to at least 2000 bar, and may be pressurised to pressure exceeding 3000 bar. The reduction of stress that results from the arrangement of the invention allows the fuel pump housing to accommodate such particularly high pressures.

The transition region may define an inner surface that flares towards the pumping chamber to define a trumpet-shaped surface. The inner surface of the transition region and a spherically-curved inner surface of the pumping chamber together may define a continuously curved surface.

The continuously curved inner surface reduces stresses at the transition between the drilling and the pumping chamber even further.

For particularly effective reduction of stresses transition between the drilling and the pumping chamber, a boundary between the curved inner surface of the transition region and the spherically-curved inner surface of the pumping chamber may be defined by at least a section of an annulus, each point on the section being a point of inflection of the continuously curved surface. The annular shaping of the opening also advantageously causes hoop stresses in the pumping chamber to be distributed around the circumference of the opening, thereby preventing the stresses from concentrating at any particular point around the perimeter of the transition region.

The drilling may comprise a main bore having a bore diameter and an intersection region between the main bore and the pumping chamber. The intersection region may comprise a neck defining a region having a neck diameter smaller than the bore diameter. The neck reduces the diameter of the drilling at the region of intersection with the pumping chamber. This reduces the dead volume of the pumping chamber (i.e. the volume of the pumping chamber that remains filled with fuel when the plunger is at its uppermost position in the plunger bore, at the end of its stroke), which increases the efficiency of the pump.

To reduce stress concentration at a boundary between the intersection region and the main bore, the intersection region may transition into the main bore at a further transition region of progressively increasing diameter.

The neck diameter may be approximately half the bore diameter of the drilling.

The neck diameter may be approximately half a diameter of the spherical pumping chamber. Advantageously, the neck diameter relative to the pumping chamber may be half the diameter of the pumping chamber. Selecting a neck diameter that is half the diameter of the pumping chamber provides a particularly effective balance between minimising stresses in pump housing, and minimising the dead volume of the pump.

The fuel pump housing may comprise a further drilling, and a diameter of the second drilling may be substantially equal to a bore diameter of the first drilling.

The further drilling may be substantially perpendicular to the drilling. Alternatively the drillings may be at an acute or obtuse angle to one another.

The drilling and/or the further drilling may extend radially from the pumping chamber.

Alternatively, one or more of the drillings may be non-radial, such that the drilling defines a drilling axis that passes through the pumping chamber at a point that is displaced from a centre point of the pumping chamber.

An opening of the drilling into the pumping chamber may be at least partially opposite to a part of the spherically-curved internal surface of the pumping chamber.

The drilling may be an outlet passage for conveying high pressure fuel, in use, from the pumping chamber to a pump outlet.

The invention also extends to a fuel pump for use in a common rail fuel injection system in a vehicle engine, the fuel pump having a fuel pump housing according to any preceding claim.

The invention extends further to a diesel engine for a vehicle comprising a fuel pump housing, the fuel pump housing comprising a pumping chamber and a drilling intersecting the pumping chamber at an opening, wherein the pumping chamber is substantially spherical, wherein the drilling transitions into the pumping chamber at a transition region of progressively increasing diameter, and wherein the transition region and the spherical pumping chamber are configured such that, when the fuel pump housing is in use, a peak stress in the fuel pump housing is at a location that is spaced away from the opening.

It will be appreciated that preferred and/or optional features of the first aspect of the invention may be incorporated alone or in appropriate combination within the second aspect of the invention also.

### BRIEF DESCRIPTION OF THE DRAWINGS

FIG. 1, which has already been described, shows a cross section of a part of a known fuel pump assembly of a fuel pump of a common rail injection system for a vehicle engine, and FIG. 2 shows a perspective view of a portion of the pump assembly shown in FIG. 1.

Preferred embodiments of the present invention will now be described, by way of example only, with reference to the accompanying drawings in which:

FIG. 3 shows a cross section of a part of a fuel pump housing of a first embodiment of the present invention, showing an intersection region between an outlet drilling for high pressure fuel and a spherical pumping chamber, and FIG. 4 shows a cross section of the same part of the pump assembly, along the line A-A of FIG. 3.

FIG. 5 shows an enlarged view of an intersection region between the outlet drilling and the pumping chamber of the fuel pump housing of FIG. 1, overlaid with stress contours illustrating the distribution of stress across the inner surface of the intersection region during operation of the pump assembly, and FIG. 6 shows a cross-section of the same part of the intersection region, along the line B-B of FIG. 5;

FIG. 7 shows an enlarged view of an intersection region between the outlet drilling and the pumping chamber of the fuel pump housing of FIG. 3, overlaid with stress contours illustrating the distribution of stress across the inner surface of the intersection region during operation of the pump assembly, and FIG. 8 shows a cross-section of the same part of the intersection region, along the line C-C of FIG. 7;

FIG. 9 is a perspective view of a cross section of the intersection region shown in FIGS. 3 and 4; and

FIG. 10 shows a cross section of a part of a fuel pump housing of a second embodiment of the present invention, showing an intersection region between an outlet drilling for high pressure fuel and a spherical pumping chamber.

### DETAILED DESCRIPTION OF PREFERRED EMBODIMENTS

References in the following description to “upper”, “lower” and “side”, and other terms having an implied orientation, are not intended to be limiting and refer only to the orientation of the parts shown in the accompanying drawings.

Referring to FIGS. 3 and 4, a fuel pump for use in a common rail fuel injection system in a diesel engine of a vehicle includes a fuel pump housing 30 in the form of a pump head. The fuel pump housing 30 is provided with a pumping chamber 32 that is intersected by first, second and third drillings 34, 36, 41.

The first drilling defines an outlet drilling 34 for carrying fuel that has been pressurised within the pumping chamber 32 to a pump outlet (not shown), which further communicates with a downstream common rail fuel injection system (also not shown).

The second drilling defines a plunger bore 36 for receiving a plunger (not shown) of the pump assembly. The plunger is arranged to reciprocate, in use, within the plunger bore 36 under the influence of a drive arrangement (not shown), as would be familiar to a person skilled in the art.

The third drilling is an inlet drilling 41 that comprises a conical region 40 adjacent to the pumping chamber 32. The internal surface of the conical region 40 defines a valve seat for an inlet valve (not shown). A fourth drilling in the form of an inlet drilling 42 intersects with the third drilling above the pumping chamber 32.

In use of the pump, fuel is delivered to the pumping chamber 32 through the inlet drilling 41 and is pressurised within the pumping chamber 32 by the plunger in the plunger bore 36. The plunger undergoes a pumping stroke in which the plunger moves from a lowermost position within the plunger bore 36 (the bottom of its stroke) to an uppermost position within the plunger bore 36 (the top of its stroke), thereby pressurising the fuel in the pumping chamber. Fuel exits the pumping chamber via the outlet drilling 34.

Considering in particular the pumping chamber 32, the pumping chamber 32 is of substantially spherical construction. That is to say, the pumping chamber 32 defines a sphere that is truncated where the pumping chamber 32 is intersected by the drillings 34, 36 41. In this way, the pumping chamber is spherically-curved and defines a spherically-curved internal surface. The spherical pumping chamber 32 has a diameter D.

Turning now to the outlet drilling 34, the outlet drilling 34 is of substantially circular cross-section. In this way, the outlet drilling 34 meets the spherical pumping chamber 32 to define a circular opening 33. At least a part of the circular opening 33 lies opposite a part of the spherically-curved internal surface of the spherical pumping chamber 32. The outlet drilling extends radially with respect to a centre of the sphere defined by the pumping chamber 32.

The outlet drilling 34 comprises a main bore 43 having a bore diameter d1a and an intersection region 44 between the main bore 43 and the pumping chamber 32. The intersection region 44 comprises a neck 45 defining a region of reduced diameter 46. The region of reduced diameter has a neck diameter d1b that is smaller than the bore diameter d1a. In particular, the neck diameter d1b is approximately half the diameter D of the pumping chamber 32. Between the neck 45 and the main bore 43 is an outlet valve (not shown).

At an end of the intersection region 44 nearest to the pumping chamber 32, the outlet drilling 34 transitions smoothly into the pumping chamber 32 at a first transition region 48. The first transition region 48 is of progressively increasing diameter moving from the region of reduced diameter 46 towards the pumping chamber 32.

In particular, the first transition region 48 flares towards the pumping chamber 32 to define a trumpet-shaped surface. The transition from the first transition region 48 into the pumping chamber 32 is continuous, such that the first transition region 48 and the pumping chamber 32 together define a continuous internal surface. The trumpet-shaped surface of the transition region 48 and the spherically-curved surface of the pumping chamber 32 meet one another tangentially. In this way, a boundary between the trumpet-shaped surface of the transition region 48 and the spherically-curved surface of the pumping chamber 32 is defined by an annulus, and each point around that annulus defines a point of inflection of the curvature of the internal surface.

At an end of the intersection region 44 nearest to the main bore 43, the intersection region 44 transitions into the main bore 43 at a second transition region 49. The second transition region 49 is of progressively increasing diameter moving from the region of reduced diameter 46 towards the main bore 43. In particular, the second transition region 48 defines a substantially conical surface.

Referring now to the plunger bore 36, the plunger bore 36 is substantially perpendicular to the outlet drilling 34, and opposite to the inlet drilling 41. The plunger bore 36 is also radial with respect to the centre of the sphere defined by the pumping chamber 32.

The plunger bore 36 is substantially cylindrical, having a diameter d2. The diameter d2 of the plunger bore 36 is substantially equal to the diameter d1a of the main bore 43 of the outlet drilling 34.

According to an aspect of the invention, a synergistic relationship between the spherical shape of the pumping chamber 32 and the curve of the first transition region 48 acts to transform the stress distribution in surprising ways, not only within the pumping chamber 32 and at the opening 33 but also within the entire intersection region 44 the outlet drilling 34.

This synergistic relationship is best explained by way of comparison between the stress distribution in known fuel pump housings of the type already described above and the stress distribution in a fuel pump housing according to an aspect of the invention.

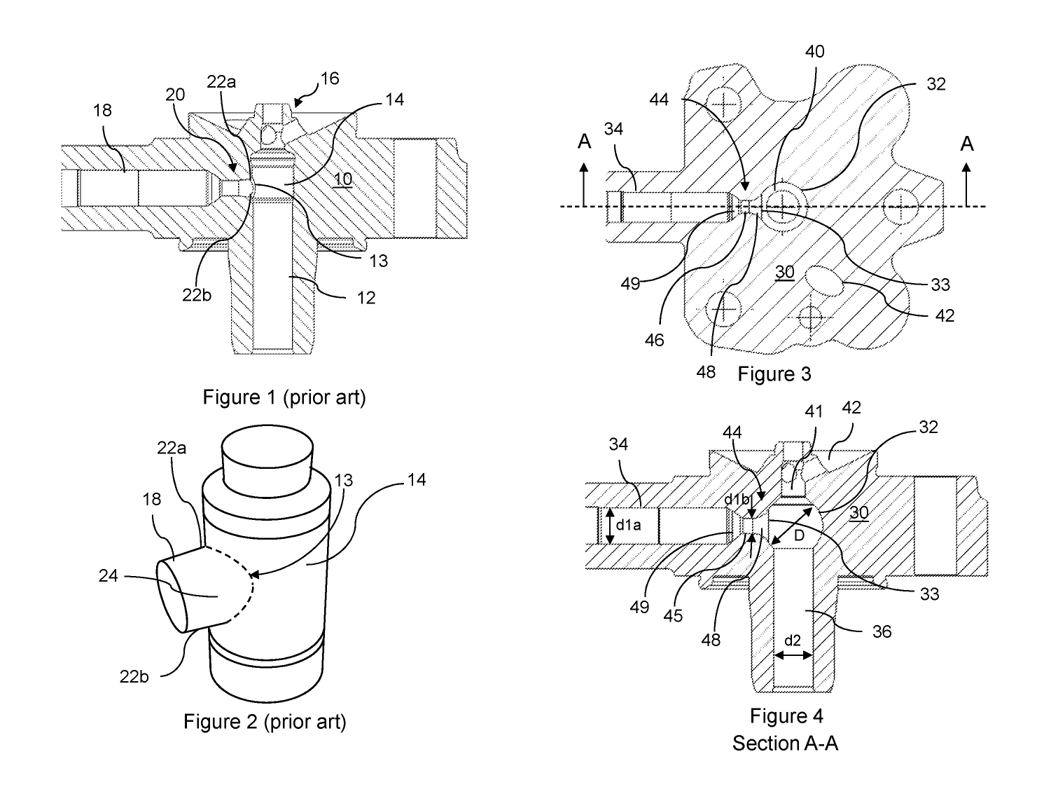

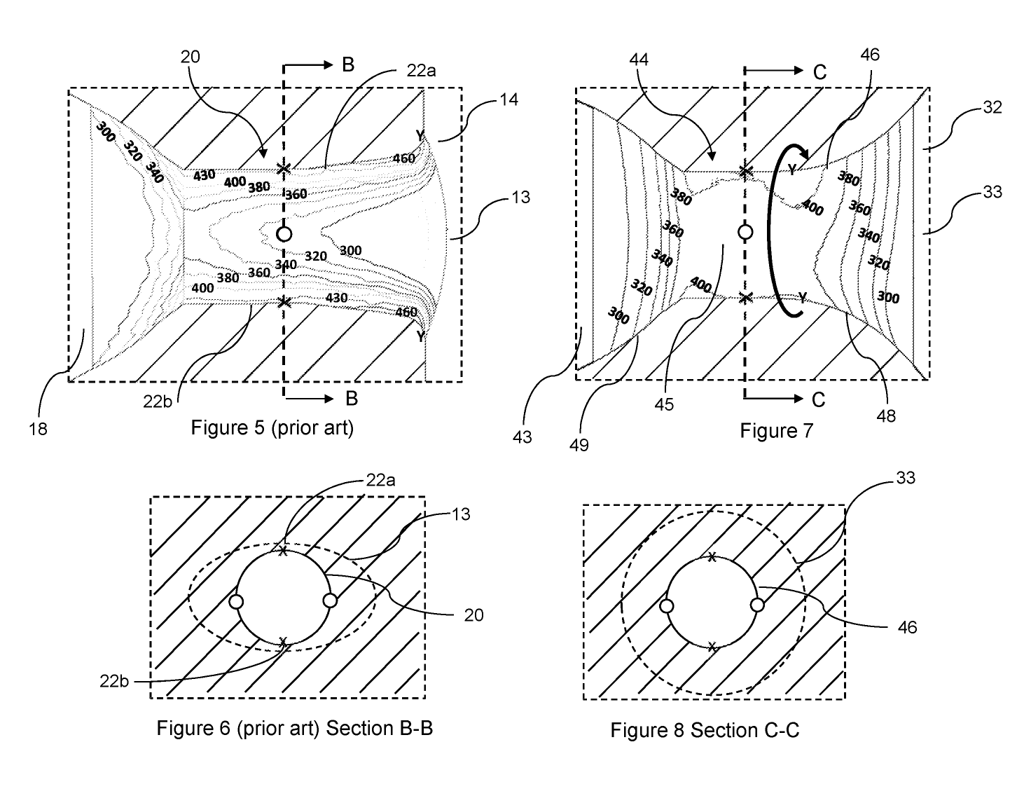

Accordingly, FIGS. 5 to 8 show comparative examples of the stress distribution within the intersection regions 20, 44 of the fuel pump housing 14 of the prior art shown in FIGS. 1 and 2, and of the fuel pump housing 30 according to an aspect of the invention, shown in FIGS. 3 and 4. Each intersection region 20, 44 is overlaid with stress contours depicting the distribution of stress within the inner surface of the respective outlet drillings 18, 34 during operation of the pump assembly.

FIG. 5 shows a close up of the intersection region 20 of the fuel pump housing 10 of FIG. 1. FIG. 6 shows a cross section of that same intersection region 20 along the line B-B. Corresponding reference points along a particular annulus of the internal surface of the intersection region are marked X and O in both FIGS. 5 and 6.

FIGS. 5 and 6 reveal that within a given annulus of the circumferential surface of the intersection region 20 the stress concentration is highly asymmetric. This is evidenced by the gathering of contour lines at the top and bottom of the annulus (marked by the letter X) indicating regions of high stress and absence of contour lines at the sides of the annulus (marked by the letter O) indicating regions of low stress.

This asymmetric distribution of stress within a given annulus of the intersection region 20 is caused by uneven stresses being induced along different longitudinal axes of the intersection region 20. These stresses in the intersection region 20 have two origins as will now be explained.

Firstly, stresses are generated in the intersection region 20 by stresses in the pumping chamber 14. An uneven distribution of hoop and axial stresses is generated within the cylindrical pumping chamber 14 as fuel is pressurised, and these uneven hoop and axial stresses in the pumping chamber 14 result in uneven stresses being applied to different parts of the intersection region 20.

Secondly, stresses are generated along the surface defined by the intersection region 20 as a result of stresses in the surface around the opening 13 between the intersection region 20 and the pumping chamber 14. The elliptical shape of the opening 13 between the intersection region 20 and the pumping chamber 14 results in an uneven distribution of stress around the opening 13, and this uneven stress distribution around the opening 13 results in different stresses being applied to different parts of the intersection region 20.

The uneven stress distribution is such that the stresses in the intersection region 20 tend to be greater at the upper and lower surfaces of the intersection region 20 (marked X on FIGS. 5 and 6) and lower at the left and right sides of the intersection region (marked O on FIGS. 5 and 6).

In addition to the uneven stress distribution within a specific annulus of the intersection region, FIG. 5 also illustrates that the stress tends to be concentrated at the opening 13. This stress concentration at the opening 13 is caused by the abrupt transition between the intersection region 20 and the pumping chamber 14.

As a result of the combination of firstly the uneven stresses induced in the intersection region 20 by the uneven stresses around the elliptical opening 13 and in the pumping chamber 14 and secondly the high stress concentration around the opening 13 due to the abrupt transition, a high peak stress is present in the intersection region and is located above and below the elliptical opening 13 at the points marked Y. Under typical operating conditions, with the pressure in the fuel pump head at 2800 bar, the peak stress in the fuel pump is found to be 522 MPa.

FIGS. 7 and 8 show a comparative situation in an intersection region 44 of a fuel pump housing 30 according to the invention. FIG. 7 shows the intersection region 44 of the fuel pump housing 30 of FIG. 1. FIG. 6 shows a cross section of that same intersection region 44 along the line C-C. Corresponding reference points along an annulus of the internal surface of the intersection region are marked X and O in both FIGS. 7 and 8.

The stress contour lines of FIGS. 7 and 8 reveal that the stress distribution in the intersection region 44 of the fuel pump housing 30 according to the invention differs significantly and unexpectedly from the stress distribution in the fuel pump housing of the known fuel pump of FIGS. 7 and 8.

Firstly, the stress is dispersed substantially evenly around any given annulus of the intersection region 44. That is to say, although a small variation in stress may be present, the distribution is significantly more even than the distribution shown in FIGS. 5 and 6. Secondly, the magnitude of the peak stress is reduced. Thirdly, and particularly surprisingly, the location of the peak stress, indicated by the letter Y, has been displaced from the region of the surface above and below opening 33 to the region of the surface that surrounds the neck 45.

This unexpected stress distribution is achieved as a result of a synergistic relationship between the spherical shape of the pumping chamber 32 and the shape of the first transition region 48, as will now be explained.

Considering first the pumping chamber 32, the spherical shape of the pumping chamber 32 acts firstly to reduce the overall stress in the pumping chamber and secondly to distribute hoop stresses evenly around the pumping chamber 32. There is no axial component to the stress since the pumping chamber 32 is of spherical construction. Removing the axial component means that stress is substantially evenly distributed in the pumping chamber 32. The stress in the pumping chamber 32 exerts a stress on the outlet drilling 34, and because the stress in the pumping chamber 32 is lower than the stress in the pumping chamber of the prior art, and is substantially evenly distributed, the stress it exerts on the outlet drilling 34 is correspondingly lower and is correspondingly substantially evenly distributed.

Turning now to the shape of the opening 33 between the outlet drilling 34 and the pumping chamber 32, the opening 33 is circular in shape owing to the spherical shape of the pumping chamber 32. As a result of the circular shape of the opening 33, rather than the elliptical shape of the opening of the prior art, the hoop stress is substantially constant around the circular opening 33. Hoop stress at the opening 33 also contributes to the stress in the outlet drilling 34; because the hoop stress is evenly distributed around the opening 33, the resulting induced stress in the outlet drilling 34 is also substantially evenly distributed.

The spherical shape of the pumping chamber therefore results in a substantially even application of stress to the body surrounding the outlet drilling 34. In particular, the stress applied at the top and bottom surfaces of the outlet drilling 34 (marked by letters X) is substantially the same as the stress applied at to the surfaces at the sides of the outlet drilling (marked by letters O). As a result, stress in the body surrounding the outlet drilling is substantially evenly distributed around any particular annulus of the outlet drilling 34, and the even distribution extends all the way back through the intersection region 44.

Considering now the shape of the first transition region 48, the smooth curve of the first transition region 48 results in lower stress in the vicinity of the opening 33 between the outlet drilling 34 and the pumping chamber 32. Surprisingly, the shape of the transition region 48 not only reduces stress in the vicinity of the opening, but also reduces the overall magnitude of the stress throughout the intersection region 44. This is because the stresses applied at the opening 33 induce stresses in the surface surrounding the intersection region 44, and the reduction in stress at the opening 33 results in a corresponding reduction in the stress applied to the intersection region 44.

Thus, in combination, the shape of the first transition region 48 and the shape of the pumping chamber 32 significantly reduce the magnitude of the stress in the entire intersection region 44.

Even more surprisingly, the combination of the reduced and evenly-distributed stress caused by the spherical shape of the pumping chamber 32 and the reduced stress caused by the shape of the transition region 48 results not only in a circumferential smoothing of the stress distribution and a lowering of the peak stress, but also results in a displacement of the peak stress away from the opening 33 altogether.

As can be seen in FIG. 7, the region of peak stress marked Y is at the neck 45 of the intersection region 44 and is not at the opening 33 as in the prior art. In fact, the region around the opening 33 is now subjected to the lowest stress of the entire intersection region 44. Under the same typical operating conditions referred to above, with a pressure of 2800 bar in the fuel pump head, the peak stress at the neck 45 is just 416 MPa, representing a 20% decrease in the peak stress compared to the known fuel pump housing of FIGS. 1 and 2. The stress at the opening 33 is reduced to less that 300 MPa, representing a decrease of more than 40% in the stress at the opening 33 compared to the known fuel pump housing of FIGS. 1 and 2.

Thus, the peak stress is lower and is located at the neck 45 of the outlet drilling 34 and not at the opening between the outlet drilling 34 and the pumping chamber 32. This is particularly advantageous because stress in the area of the neck 45 is less sensitive to geometry variation within the pumping chamber 32 than stress at the opening 33. The neck 45 is less influenced by the hoop stress in the pumping chamber 32, which means that the periodic fluctuations in the peak stress that result from the periodic stresses in the pumping chamber 32 are less intense, and the pump housing 30 is less prone to fatigue failure.

The neck 45 of the intersection region 44 also provides an advantageous effect.

Stress could be reduced in the pumping chamber 32 and the outlet drilling 44 by selecting a main bore diameter d1a that is equal to the diameter D of the pumping chamber 32. However, increasing the diameter d1a of the drilling also increases the size of the opening 33, which in turn increases the overall hoop stress. Furthermore, increasing the diameter of the drilling increases the dead volume of the pumping chamber (i.e. the volume of the pumping chamber 32 that remains filled with fuel when the plunger is at its uppermost position in the plunger bore, at the end of its stroke), which decreases the efficiency of the pump. This leads to conflicting requirements: a bore diameter that is large enough to be equal to the diameter of the pumping chamber 34 would minimise certain stresses, while a smaller bore diameter would increase efficiency of the pump.

The required balance can be achieved by virtue of the neck 45, which connects the pumping chamber 32 to the main bore 43 via the non-return valve (not shown). The neck 45 allows the diameter of the outlet drilling 34 to be reduced to the neck diameter d1b in the vicinity of the opening 33, thereby reducing the dead volume of the pumping chamber and increasing efficiency of the pump, but still allows a larger diameter d1a of the main bore 43, such that the diameter d1a of the main bore 43 can match the diameter D of the pumping chamber 32. The inventors have found that when the neck diameter d1b is approximately half the main bore diameter d1a, a particularly advantageous balance of the requirements of pump efficiency and stresses at the opening 33 is achieved.

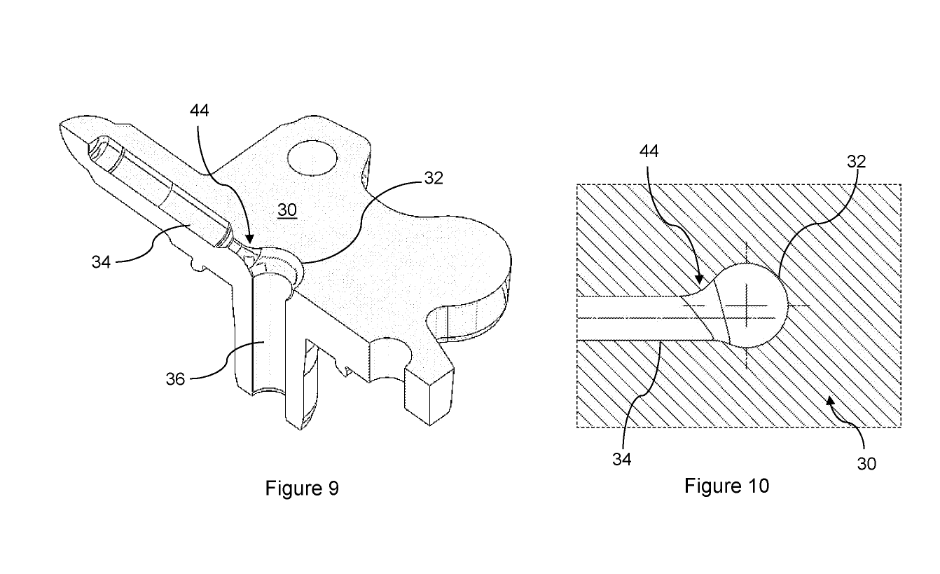

With reference to FIG. 9, the plunger bore 36, the outlet drilling 34 and the inlet drilling 41 (not visible in FIG. 9, but visible in FIG. 3) each extend radially from a centre point of the spherical pumping chamber 32, and the outlet drilling 34 is arranged perpendicularly to the plunger bore 36 and the inlet drilling 41. However, the angle between the drillings need not be 90° and may be any suitable angle.

Furthermore, the drillings need not extend radially with respect to the sphere defined by the pumping chamber. For example, FIG. 10 illustrates an alternative embodiment, in which the outlet drilling is non-radial with respect to the pumping chamber. In particular, a longitudinal axis defined by the outlet drilling 34 passes through the pumping chamber 32 at a point that is displaced from the centre point of the pumping chamber 32.

Due to the spherical geometry of pumping chamber 32, changing the angle between the drillings, or arranging the drillings in non-radial configurations relative to the centre point of the pumping chamber 32, does not incur a significant increase in the concentration of stress within the intersection region 44. The arrangement can therefore accommodate complex drilling geometries without detrimental effect to the peak stress in the pumping chamber 32, and hence without detrimental effect to the life of the pump.

In the embodiment of the invention described above, the diameter D of the pumping chamber 32 is substantially the same as the diameter, d1a, of the main bore 43 of the outlet drilling 34 and is also substantially the same as the diameter d2, of the plunger bore 36. In practice, the inventors have found that the lowest stress is produced when the outlet drilling 34 and the plunger bore 36 have the same diameter. However, in other embodiments (not shown), these diameters, d1a, d2 and D, need not be equal.

It will be appreciated by a person skilled in the art that the invention could be modified to take many alternative forms without deviating from the scope of the appended claims.

1-15. (canceled)

16. A fuel pump housing for use in a fuel pump of a common rail fuel injection system in a vehicle engine, the fuel pump housing comprising:
a pumping chamber for receiving pressurised fuel, wherein the pumping chamber is substantially spherical; and
a drilling intersecting the pumping chamber at an opening, wherein the drilling transitions into the pumping chamber at a transition region of progressively increasing diameter;
wherein the transition region and the pumping chamber are configured such that, when the fuel pump housing is in use, a peak stress in the fuel pump housing is at a location that is spaced away from the opening.

17. The fuel pump housing of claim 16, wherein the transition region defines an inner surface that flares towards the pumping chamber to define a trumpet-shaped surface.

18. The fuel pump housing of claim 17, wherein the inner surface of the transition region and a spherically-curved inner surface of the pumping chamber together define a continuously curved surface.

19. The fuel pump housing of claim 18, wherein a boundary between the inner surface of the transition region and the spherically-curved inner surface of the pumping chamber is defined by at least a section of an annulus, each point on the section of the annulus being a point of inflection of the continuously curved surface.

20. The fuel pump housing of claim 16, wherein the drilling comprises a main bore having a bore diameter and an intersection region between the main bore and the pumping chamber, the intersection region comprising a neck defining a region having a neck diameter smaller than the bore diameter.

21. The fuel pump housing of claim 20, wherein the intersection region transitions into the main bore at a further transition region of progressively increasing diameter.

22. The fuel pump housing of claim 20, wherein the neck diameter is approximately half the bore diameter of the drilling.

23. The fuel pump housing of claim 20, wherein the neck diameter is approximately half a diameter of the pumping chamber.

24. The fuel pump housing of claim 16, wherein the fuel pump housing comprises a further drilling, and wherein a diameter of the further drilling is substantially equal to a bore diameter of the drilling.

25. The fuel pump housing of claim 24, wherein the further drilling is substantially perpendicular to the drilling.

26. The fuel pump housing of claim 24, wherein the drilling and/or the further drilling extend radially from the pumping chamber.

27. The fuel pump housing of any of claim 16, wherein the drilling defines a drilling axis that passes through the pumping chamber at a point that is displaced from a centre point of the pumping chamber.

28. The fuel pump housing of claim 16, wherein the opening of the drilling into the pumping chamber is at least partially opposite to a part of a spherically-curved inner surface of the pumping chamber.

29. The fuel pump housing of claim 16, wherein the drilling is an outlet passage for conveying high pressure fuel, in use, from the pumping chamber to a pump outlet.

30. A fuel pump for use in a common rail fuel injection system in a vehicle engine, the fuel pump comprising:
a fuel pump housing having a pumping chamber for receiving pressurised fuel, wherein the pumping chamber is substantially spherical and also having a drilling intersecting the pumping chamber at an opening, wherein the drilling transitions into the pumping chamber at a transition region of progressively increasing diameter;
wherein the transition region and the pumping chamber are configured such that, when the fuel pump housing is in use, a peak stress in the fuel pump housing is at a location that is spaced away from the opening.
